(19) United States
(12) Patent Application Publication
(10) Pub. No.: US 2025/0295092 A1
(43) Pub. Date: Sep. 25, 2025

(54) TELESCOPIC PET WATER CONTAINER FOR CUP HOLDERS

(71) Applicant: Joshua Brazeal, Franklin, GA (US)

(72) Inventor: Joshua Brazeal, Franklin, GA (US)

(21) Appl. No.: 18/609,931

(22) Filed: Mar. 19, 2024

(51) Int. Cl. A01K 7/00; A01K 5/01

(52) U.S. Cl. CPC A01K 7/00; A01K 5/0121

(57) ABSTRACT

A telescopic pet water container for cup holders, including a main body, including a first telescopic section, a second telescopic section telescopically connected to the first telescopic section, and a third telescopic section telescopically connected to the second telescopic section, and a seal top disposed at a top portion of the main body to enclose water disposed within the main body, such that the seal top creates a water-tight seal.

### BACKGROUND

### 1. Field

The present general inventive concept relates generally to pet water container, and particularly, to a telescopic pet water container for cup holders.

### 2. Description of the Related Art

Ensuring a pet has access to fresh drinking water can be a challenge, especially when on the go.

In addition, when pet owners travel with their pets, multiple items are often required to ensure a pet has access to an array of products, which can be inconvenient and difficult to transport.

Therefore, there is a need for a device that allows a pet to have access to a secure water and/or food container while the pet is traveling in a vehicle.

### SUMMARY

The present general inventive concept provides telescopic pet water container for cup holders.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a telescopic pet water container for cup holders, including a main body, including a first telescopic section, a second telescopic section telescopically connected to the first telescopic section, and a third telescopic section telescopically connected to the second telescopic section, and a seal top disposed at a top portion of the main body to enclose water disposed within the main body, such that the seal top creates a water-tight seal.

The telescopic pet water container for cup holders may further include a saucer removably disposed on a top upper lip portion of the main body, such that the seal top connects the saucer to the top upper lip portion of the main body when the seal top is disposed at the top portion the main body.

The third telescopic section may have a circumference that is smaller than a circumference of the second telescopic section, and the second telescopic section may have a circumference that is smaller than a circumference of the first telescopic section.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a telescopic pet water container for cup holders in a contracted state, according to an exemplary embodiment of the present general inventive concept; and

FIG. 2 illustrates a telescopic pet water container for cup holders in an extended state, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### List of Components

Telescopic Pet Water Container 100 For Cup Holders
Main Body 110
First Telescopic Section 111
Second Telescopic Section 112
Third Telescopic Section 113
Saucer 120
Seal Top 130
Pull Tab 131

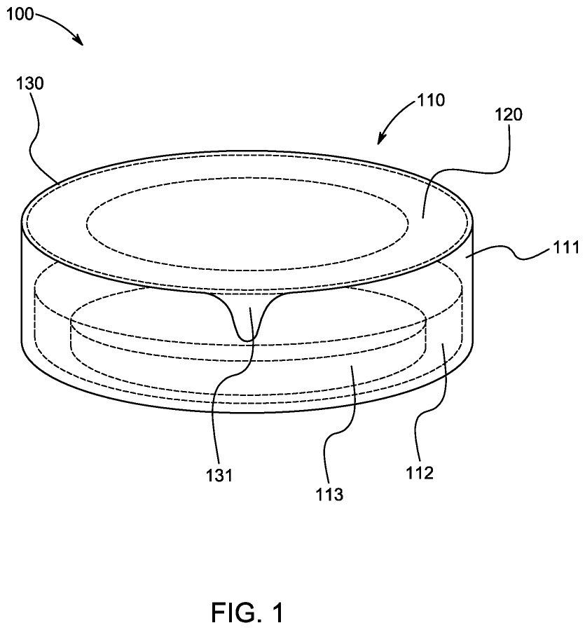

FIG. 1 illustrates a telescopic pet water container for cup holders 100 in a contracted state, according to an exemplary embodiment of the present general inventive concept.

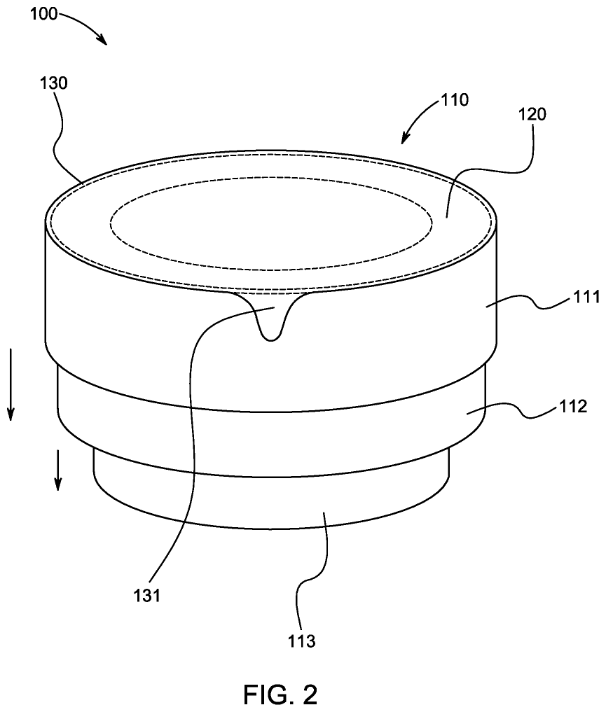

FIG. 2 illustrates the telescopic pet water container for cup holders 100 of FIG. 1 in an extended state, according to an exemplary embodiment of the present general inventive concept.

The telescopic pet water container for cup holders, and all components therein and/or connected thereto, may be constructed from at least one of metal, plastic, wood, silicone, glass, and rubber, etc., but is not limited thereto, and can be constructed from any material known to one of ordinary skill in the art.

Referring to FIG. 1, the telescopic pet water container for cup holders 100 may include a main body 110, a saucer 120, and a seal top 130, but is not limited thereto.

The telescopic pet water container for cup holders 100 may include water disposed there inside, but is not limited thereto, and can alternatively house there inside food or other material.

The telescopic pet water container for cup holders 100 may be sold in stores as a pre-filled water container and/or a pre-filled food container.

The seal top 130 may cover an entire opening of a top portion of the main body 110, and may be removable from the main body 110 by pulling on a tab 131.

When the seal top 130 is removed from the main body 110, the saucer 120 may be exposed. The saucer 120 is removable from the top portion of the main body 110, and may include an outer lip portion that can securely snap onto a top lip portion of a top edge of the main body 110.

When the saucer 120 is removed from the main body 110, water and/or food that is stored within the main body 110 may be exposed, thereby giving a pet access to the water and/or food disposed within the main body 110.

Referring to FIGS. 1 and 2, the main body 110 may include a first telescopic section 111, a second telescopic section 112, and a third telescopic section 113, but is not limited thereto, and may include less or more telescopic sections based on a manufacturer's preference. Even though the first telescopic section 111 is referred to as a “telescopic section,” the first telescopic section 111 is not itself telescopic, but is referred to as the first telescopic section 111 in order to demonstrate that the second telescopic section 112 may be retracted to be disposed inside the first telescopic section 111 via a telescopic-type action.

Referring to FIG. 1, the telescopic pet water container for cup holders 100 is illustrated in a contracted state, such that the third telescopic section 113 is disposed within the second telescopic section 112, and the second telescopic section 112 is disposed within the first telescopic section 111.

Referring to FIG. 1, the telescopic pet water container for cup holders 100 is illustrated in a contracted state, such that the third telescopic section 113 is disposed within the second telescopic section 112, and the second telescopic section 112 is disposed within the first telescopic section 111.

Referring to FIG. 2, the telescopic pet water container for cup holders 100 is illustrated in an extended state, such that the third telescopic section 113 is disposed within the second telescopic section 112, and the second telescopic section 112 is disposed within the first telescopic section 111.

Referring to FIG. 2, the third telescopic section 113 has a circumference that is smaller than a circumference of the second section 112, and the second telescopic section 112 has a circumference that is smaller that a circumference of the first telescopic section 111.

Accordingly, a user can extend the telescopic pet water container for cup holders 100 based on a preference of the user, in order to allow the telescopic pet water container for cup holders 100 to securely fit inside a cup holder of a vehicle, so that a pet (e.g., dog, cat, etc.) that is riding in the vehicle can have water to drink and/or food to eat from a secured container. In other words, the telescopic pet water container for cup holders 100 is secured because it is securely placeable within in a cup holder, regardless of the size of the cup holder, because the first telescopic section 111, the second telescopic section, 112 and the third telescopic section 113 all have different circumferences, thereby allowing the telescopic pet water container for cup holders 100 to be universally placeable in cup holders of varying sizes.

The first telescopic section 111, the second telescopic section 112, and the third telescopic section 113 may be flexibly and/or deformably connected to each other, respectively, to allow for easy expansion and retraction.

The present general inventive concept may include a telescopic pet water container for cup holders 100, including a main body 110, including a first telescopic section 111, a second telescopic section 112 telescopically connected to the first telescopic section 111, and a third telescopic section 113 telescopically connected to the second telescopic section 112, and a seal top 130 disposed at a top portion of the main body 110 to enclose water disposed within the main body 110, such that the seal top 130 creates a water-tight seal.

The telescopic pet water container for cup holders 100 may further include a saucer 120 removably disposed on a top upper lip portion of the main body 110, such that the seal top 130 connects the saucer 120 to the top upper lip portion of the main body 110 when the seal top 130 is disposed at the top portion the main body 110.

The third telescopic section 113 may have a circumference that is smaller than a circumference of the second telescopic section 112, and the second telescopic section 112 may have a circumference that is smaller than a circumference of the first telescopic section 111.

A purpose of the present general inventive concept is to provide users with a pre-filled disposable water (or food) bowl for pets. Ensuring a pet has access to fresh drinking water can be a challenge, especially when on the go. In addition, when caregivers travel with their pets, it often requires a commitment to carry multiple items, to ensure a pet has access to an array of products which can be inconvenient and difficult to transport. Ingenious and practical, the present general inventive concept offers a modern accessory that eliminates the need for additional containers or bowls as it provides a ready-to-use, disposable water bowl that pets can enjoy, at all times. Expanding on the initial design of an average water bowl, the present general inventive concept introduces a novel disposable bowl that is pre-filled with clean drinking water to guarantee pets have access to fresh drinking water at any time, and in any location. Users simply remove the economical feature of a top-layered plastic saucer, then pull off the foil seal on the bowl to dispense fresh water for the pet. This innovative, top-quality product eliminates the hassle of filling and carrying separate water containers and provides a mess-free solution to keep a pet hydrated while on the go. Furthermore, the saucer can serve as an alternative drinking vessel in the event the pet does not like the primary container as some pets don't like their whiskers touching the side of a bowl. As a result, the present general inventive concept may prove to be essential in the pet industry providing a great convenience for all pet owners.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A telescopic pet water container for cup holders,
comprising: a main body, comprising:
a first telescopic section,
a second telescopic section telescopically connected to the first telescopic section, and
a third telescopic section telescopically connected to the second telescopic section; and
a seal top disposed at a top portion of the main body to enclose water disposed within the main body, such that the seal top creates a water-tight seal.

2. The telescopic pet water container for cup holders of claim 1, further comprising:
a saucer removably disposed on a top upper lip portion of the main body, such that the seal top connects the saucer to the top upper lip portion of the main body when the seal top is disposed at the top portion the main body.

3. The telescopic pet water container for cup holders of claim 1, wherein the third telescopic section has a circumference that is smaller than a circumference of the second telescopic section, and the second telescopic section has a circumference that is smaller than a circumference of the first telescopic section.
